(19) United States
(12) Patent Application Publication
(10) Pub. No.: US 2010/0140946 A1
(43) Pub. Date: Jun. 10, 2010

(54) SYSTEM AND METHOD FOR GENERATING POWER BY RIVER FLOW

(76) Inventor: XINGYU ZHENG, BEIJING (CN)

Correspondence Address: J C PATENTS, 4 VENTURE, SUITE 250, IRVINE, CA, 92618, US

(21) Appl. No.: 12/341,880

(22) Filed: Dec. 22, 2008

(30) Foreign Application Priority Data
Dec. 5, 2008 (CN) 200810239059.0

(51) Int. Cl. F03B 13/00

(52) U.S. Cl. 290/54

(57) ABSTRACT

The present invention relates to a system and a method for generating power by river flow. The system includes: a wheel disc fixedly disposed relatively to water current; a floating body floating on the water current; a baffle disposed on the floating body, inserted into the water current during generating power, and driving the floating body to run downstream with the push of the water current; a flexible chain with one end fixedly connected to the floating body and the other end wound around the wheel disc, and dragged to drive the wheel disc to rotate when the floating body runs downstream with the push of the water current; and a power generator connected to a rotation axis of the wheel disc and driven for generating power when the wheel disc rotates. The method may be a method executed by the system in the present invention. Another method comprises: two floating bodies running to alternately drive two wheel discs for generating power. The present invention can fully utilize kinetic energy resource of water current so as to increase the amount of power generation and the implementing method is simple and convenient to be promoted at water areas of various rivers.

### CROSS-REFERENCE TO RELATED APPLICATIONS

This application claims priority to Chinese Patent Application No. 200810239059.0, filed on Dec. 5, 2008, entitled “System and Method for Generating Power by River Flow”, which is incorporated herein by reference in its entirety.

### FIELD OF THE TECHNOLOGY

The present invention relates to hydroelectric power generation technology, particularly relates to a system for generating power by river flow and a method for generating power by river flow executed by the system.

### BACKGROUND

With depletion of traditional fossil energy such as petroleum, coal etc., the situation of “energy crisis” in the world is getting worse. Exploitation and utilization of renewable energy has been particularly focused on. As an important part of natural renewable resources, water has become a renewable energy development in one of the leading parts of renewable energy in the future. Currently, hydroelectric power generation system has been widely used at areas with abundant water resource such as rivers and lakes because its advantages such as clean, large reserves, inexhaustible in supply and always available for use.

In prior art, the equipment commonly used for generating power by river flow is a turbomachine, which mainly includes an impeller, a transmission shaft, a bearing base, a motive power output wheel and a power generator. During working, it drives the impeller to rotate by utilizing water current; the transmission shaft connected with the impeller drives the power generator to work so as to transform kinetic energy of the water current into electric energy.

However, disadvantages of the method for generating power by river flow are as follows:

During rotation of the impeller, the angle of each blade keeps changing after it enters water, which results in inadequate use of kinetic energy of the water current. Besides, the volume and scale of the turbomachine is limited, which results in inadequate use of kinetic energy of the water current in the river flow. In addition, most of the existing power generation equipments by river flow need a dam, which causes huge cost and is difficult to realize.

### SUMMARY

The object of the present invention is to provide a system for generating power by river flow and a method for generating power by river flow in order to improve utilization ratio of kinetic energy of the water current and increase the amount of power generation.

In order to implement the above object, the present invention provides a system for generating power by river flow, including:
a wheel disc fixedly disposed relatively to water current;
a floating body floating on the water current;
a baffle disposed on the floating body, inserted into the water current during generating power, and driving the floating body to run downstream with the push of the water current;
a flexible chain with one end fixedly connected to the floating body and the other end wound around the wheel disc, and dragged to drive the wheel disc to rotate when the floating body runs downstream with the push of the water current; and
a power generator connected to a rotation axis of the wheel disc through a transmission, and driven for generating power when the wheel disc rotates.

In order to implement the above object, the present invention further provides a method for generating power by river flow, including:
a baffle driving a floating body to run downstream with the push of water current when the baffle disposed on a floating body is inserted into the water current, wherein the floating body is connected one end of a flexible chain, the other end of the flexible chain is wound around a wheel disc fixedly disposed relatively to the water current;
the floating body dragging the wound flexible chain to drive the wheel disc to rotate when the floating body runs downstream with the push of the water current; and
the rotated wheel disc driving a power generator for generating power.

In order to implement the above object, the present invention further provides another method for generating power by river flow, including:
a baffle driving a first floating body to run downstream with the push of the water current when the baffle disposed on the first floating body is inserted into water current, wherein the first floating body is connected with one end of a first flexible chain, the other end of the first flexible chain is wound around a first wheel disc fixedly disposed relatively to the water current;
dragging the wound first flexible chain to drive the first wheel disc to rotate when the first floating body runs downstream with the push of the water current;
the rotated first wheel disc engaging with a power generator through a first clutch and driving the power generator for generating power through a transmission;
at the same time, disconnecting a second wheel disc from the power generator through a second clutch, making the second wheel disc rotate under the first power device's driving, and winding the second flexible chain connected to the second wheel disc;
the wound second flexible chain driving the connected second floating body to run upstream; and
the first floating body and the second floating body running downstream and upstream alternately, wherein running scopes are not overlapped in a flowing direction of the water current.

It can be seen from the above technical solution that the present invention adopts water current to push the baffle, drives the floating body to move horizontally and then transforms horizontal movement of the floating body into rotation of the wheel disc for generating power through a flexible chain. This technical means overcomes the technical problem in prior art that the angle of the turbomachine's blade into water keeps changing, which can not fully utilize kinetic energy of the water current. The width of the floating body of the present invention may be disposed quite wide. Preferably, the width is disposed to be close to the width of riverway of the water current. The present invention can fully utilize kinetic energy resource of the water current, increase the amount of power generation and the implementing method is simple and easy to be promoted in a variety of river water areas.

The present invention will be described in more detail with reference to the drawings and embodiments.

### BRIEF DESCRIPTION OF THE DRAWINGS

FIG. 1 is a structure schematic view of Embodiment 1 of the system for generating power by river flow in accordance with the present invention;

FIG. 2 is a structure schematic view of Embodiment 2 of the system for generating power by river flow in accordance with the present invention;

FIG. 3 is a structure schematic view illustrating the baffle moving away from the water current in Embodiment 2 of the system for generating power by river flow in accordance with the present invention;

FIG. 4 is a structure schematic view of Embodiment 3 of the system for generating power by river flow in accordance with the present invention;

FIG. 5 is a structure schematic view of Embodiment 4 of the system for generating power by river flow in accordance with the present invention;

FIG. 6 is a structure schematic view of Embodiment 5 of the system for generating power by river flow in accordance with the present invention;

FIG. 7 is a structure schematic view of one Embodiment 6 of the system for generating power by river flow in accordance with the present invention;

FIG. 8 is a structure schematic view of another Embodiment 6 of the system for generating power by river flow in accordance with the present invention;

FIG. 9 is a structure schematic view of Embodiment 7 of the system for generating power by river flow in accordance with the present invention;

FIG. 10 is a structure schematic view of Embodiment 8 of the system for generating power by river flow in accordance with the present invention;

FIG. 11 is a flowchart of the embodiment of the method for generating power by river flow in accordance with the present invention.

In figures:

| | | | | | |
|---|---|---|---|---|---|
| 1 | floating body | 2 | baffle | 3 | wheel disc |
| 4 | flexible chain | 5 | power generator | 6 | first power device |
| 7 | pivot spindle | 8 | transmission | 9 | third power device |
| 10 | engaging and | 11 | first floating body | 12 | second floating body |
| | disengaging gear | | | | |
| 31 | first wheel disc | 32 | second wheel disc | 41 | first flexible chain |
| 42 | second flexible chain | 81 | first transmission | 82 | second transmission |
| 101 | first pulley | 102 | second pulley | 103 | third pulley |
| 104 | first engaging and | 105 | second engaging and | 106 | fourth power device |
| | disengaging gear | | disengaging gear | | |
| 107 | fifth power device | 108 | fourth pulley | | |

### DETAILED DESCRIPTION

### Embodiment 1 of the System for Generating Power by River Flow

As shown in FIG. 1, it is a structure schematic view of Embodiment 1 of the system for generating power by river flow in accordance with the present invention. The system may be disposed in any river water area with kinetic energy of water current and utilize directional water current in the river flow to generate power. The system may specifically include a wheel disc 3, a floating body 1, a baffle 2, a flexible chain 4 and a power generator 5. The wheel disc 3 is fixedly disposed relatively to the water current and may be fixed into river bottom or onto a dam or bank. The power generator 5 is connected with a rotation axis of the wheel disc 3 by a transmission 8. When the wheel disc 3 rotates, it may drive the power generator 5 to rotate so as to generate power. The wheel disc 3 is preferably hanged over river surface specifically by rotation transferring formed in the manner of a beam frame, a pulley or a gear. The floating body 1 floats on the water current specifically by adopting a conventional boat body as the floating body 1. Such boat may be called power generation boat. The baffle 2 is disposed on the floating body 1. During generating power, the baffle 2 is inserted into the water current and an angle is formed between the direction of the baffle 2 and the direction of the water current. Preferably, the angle between the direction of the baffle 2 and the flowing direction of the water current is about 90° so as to obtain kinetic energy of the water current to the maximum extent. The baffle 2 may drive the floating body 1 to run downstream with the push of the water current. One end of the flexible chain 4 is fixedly connected to the floating body 1. The other end of the flexible chain 4 is wound and connected to the wheel disc 3. When the floating body 1 runs downstream with the push of the water current, it drags the wound flexible chain 4 and drives the wheel disc 3 to rotate together.

The procedure of power generation of the system for generating power by river flow in the present embodiment specifically is as follows: firstly, the baffle is inserted into the water current, with the push of the water current and the baffle drives the floating body to run downstream together; the floating body drags the flexible chain to make it be loosened from the wheel disc and the wheel disc rotates along the direction in which the flexible chain is loosened so as to drive the connected power generator to rotate and generate power.

The system for generating power by river flow in the present embodiment utilizes a power generation boat running downstream to drive the wheel disc and the power generator to rotate and generate power. The baffle is immerged into the water current all the time and the angle is basically keeps the same. Therefore, kinetic energy of the water current may be fully utilized for generating power, which greatly increases the amount of power generated. The floating body keeps floating on the water current all the time, which can reduce resistance and is not easily damaged due to corrosion. Besides, equipments of the system are simply constructed, which is easy to form large-scale hydroelectric power generation station at broad water areas especially suitable for being disposed in the Yellow River's water area. The water current of the Yellow River is not suitable for boats running. Therefore, the hydroelectric power generation station formed by the system for generating power by river flow in the present embodiment may be constructed at open water areas. A plurality of groups of wheel discs and power generation boats may be disposed side by side; or a baffle floating body with width similar to the river bed's width may be disposed; or a wheel disc and a power generation boat are disposed by being connected in series. The running scopes of the power generation boats are not overlapped in the flowing direction of the water current so as utilize water current resource to the maximum extent.

### Embodiment 2 of the System for Generating Power by River Flow

As shown in FIG. 2, it is a structure schematic view of Embodiment 2 of the system for generating power by river flow in accordance with the present invention. The present embodiment is based on the above Embodiment 1 and is further provided with a first power device 6. The first power device 6 which may be an electromotor is connected with the wheel disc 3 and is adapted to drive the wheel disc 3 to rotate when power generation stops. The rotation of the wheel disc 3 may wind the flexible chain 4 so as to drive the floating body 1 to run upstream towards the wheel disc 3 and re-wind the flexible chain 4 around the wheel disc 3.

The technical solution of the present embodiment enables the floating body not only to run downstream for generating power but also to run upstream back to the starting point under the power device's driving so as to restart the next power generation.

During the power generation stopping and the floating body 1 running upstream back, the baffle 2 preferably moves away from the water current so as to reduce resistance. Specifically, a position adjacent to one end of the baffle 2 may be pivotally connected with the floating body 1 and a pivot spindle 7 is disposed horizontally. The pivot spindle 7 may be connected with a third power device 9. When the floating body 1 runs upstream and stops generating power, the third power device 9 drives the pivot spindle 7 to rotate so as to drive the baffle 2 to rotate and until make the baffle 2 upwarp and move away from the water current. As shown in FIG. 3, the baffle 2 rotates to become over the water surface.

In the above technical solution, the baffle pivotally connected with the floating body may conveniently change positions. When the floating body is running downstream for generating power, the baffle is inserted into water; and when it is running upstream and the power generation stops, the baffle moves away from water to reduce resistance. Furthermore, during generating power downstream, the amount of the thrust borne by the baffle may be adjusted by adjusting the angle of the baffle into water so as to control the running speed of the floating body to accommodate different practical needs.

### Embodiment 3 of the System for Generating Power by River Flow

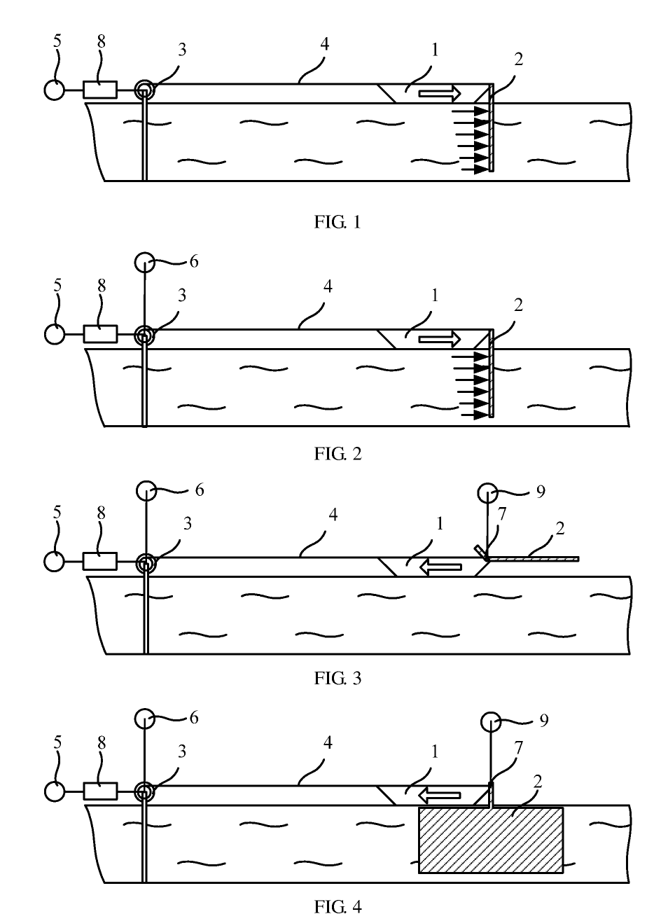

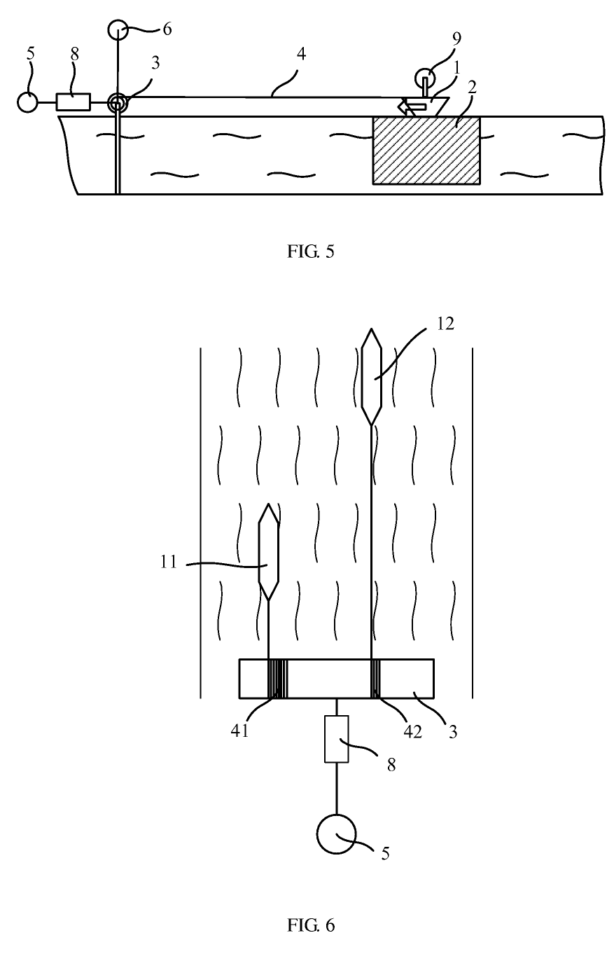

As shown in FIG. 4, it is a structure schematic view of Embodiment 3 of the system for generating power by river flow in accordance with the present invention. The present embodiment is similar to the above Embodiment 2. One end of the baffle 2 is pivotally connected with the floating body 1 with difference that the pivot spindle 7 is disposed vertically. When the floating body 1 runs upstream and the power generation stops, the connected third power device 9 may drive the pivot spindle 7 to rotate so as to drive the baffle 2 to rotate to the downstream direction of the water current i.e. rotate to make the baffle 2 become substantially parallel to the flowing direction of the water current, as shown in FIG. 4.

The technical solution of the present embodiment may also reduce the resistance by rotating the baffle when the floating body returns back and the force needed to rotate the baffle is less.

### Embodiment 4 of the System for Generating Power by River Flow

As shown in FIG. 5, it is a structure schematic view of Embodiment 4 of the system for generating power by river flow in accordance with the present invention. The present embodiment is based on the above Embodiment 1. The baffle 2 is fixedly disposed on the floating body 1. When the floating body 1 is a boat body, the direction of the baffle 2 is vertical to the direction of the boat body. When the floating body 1 runs downstream, the baffle 2 is vertical to the flowing direction of the water current, which may obtain the biggest water current thrust. When the floating body 1 stops generating power and needs to run upstream back, the third power device 9 disposed on the floating body 1 may be adapted to drive the floating body 1 itself to rotate so as to drive the baffle 2 to rotate together until the baffle 2 rotates to the downstream direction of the water current i.e. substantially parallel to the flowing direction of the water current.

The technical solution of the present embodiment may rotate the baffle by rotating the power generation boat itself in order to achieve the aim of reducing resistance when the power generation boat returns back.

### Embodiment 5 of the System for Generating Power by River Flow

As shown in FIG. 6, it is a structure schematic view of Embodiment 5 of the system for generating power by river flow in accordance with the present invention. In specific implementation, the cooperative relationship of the baffle, the floating body and the wheel disc may change a lot. For example, the number of the baffle is not limited to one. There may be a plurality of baffles disposed on one floating body. The baffles may be disposed paratactically along the flowing direction of the water current or be disposed side by side or be disposed with a certain angle, which may be determined according to specific practical situations. The cooperation of the wheel disc and the floating body may also change.

In the present embodiment, as shown in FIG. 6, the number of the wheel disc 3 may be one. There may be two flexible chains independently wound around the wheel disc 3 side by side i.e. a first flexible chain 41 and a second flexible chain 42. One of the flexible chains is in a winding state and the other flexible chain is in a loosing state. One end of the first flexible chain 41 and one end of the second flexible chain 42 are respectively connected to a floating body i.e. a first floating body 11 and a second floating body 12. For example, when the first flexible chain 41 is in a winding state, the first floating body 11 connected with the flexible chain 41 runs downstream with the push of the water current. The wound first flexible chain 41 is loosened and drives the wheel disc 3 to rotate so as to drive the power generator 5 to rotate for generating power. The second flexible chain 42 connected with the second floating body 12 is in a loosing state. Under the driving of the rotated wheel disc 3, the loosened second flexible chain 42 is wound around the wheel disc 3 and drives the second floating body 12 to run upstream. The first floating body 11 and the second floating body 12 run downstream and upstream alternately.

During the working procedure of the system for generating power by river flow in accordance with the present embodiment, two floating bodies run downstream and upstream alternately. The floating body running downstream generates power and drives the other floating body to run upstream. The specific working procedure is explained by taking the first floating body's running downstream as an example as follows:

During generating power, the first floating body inserts its baffle into the water current and forms a first resistance angle between the direction of its baffle and the flowing direction of the water current. Preferably, an angle of 90° is formed between the direction of its baffle and the flowing direction of the water current so as to obtain kinetic energy of the water current to the maximum extent. The baffle may drive the first floating body where the baffle is located to run downstream with the push of the water current. The first floating body running downstream draws the first flexible chain to be loosened and drive the wheel disc to rotate. On one hand, the rotated wheel disc may drive the power generator to rotate for generating power; on the other hand, it drives the second flexible chain to be wound at the same time and draws the second floating body connected to the second flexible chain to run upstream towards the wheel disc. The baffle on the second floating body running upstream is rotated to move away from the water current or is rotated to form a second resistance angle with the flowing direction of the water current. The second resistance angle is less than the first resistance angle and preferably parallel to the flowing direction of the water current. The thrust of the water current to the baffle on the first floating body is remarkably greater than the thrust to the baffle on the second floating body. When the second floating body returns back to the wheel disc, the second floating body runs downstream to draw the first floating body to return back. This performed repeatedly and alternately to make the wheel disc rotate in a forward direction and in a reverse direction alternately so as to drive the power generator for generating power.

In the present embodiment, one wheel disc is connected with two floating bodies. At the same time when one runs downstream, the other one returns upstream. The two floating bodies are power devices for each other. They alternately drag the wheel disc to rotate. Specifically, a commutator may be disposed between the power generator and the wheel disc to adjust the rotation direction of the wheel disc and drive the power generator to continuously operating along the same direction.

The technical solution of the present embodiment can reduce the disposing of the power device so as to reduce device cost. When the power generation station is specifically under construction, a plurality of groups of system for generating power by river flows may be disposed. For example, a plurality of floating bodies are laterally disposed on the river surface side by side and operated at the same time so as to form a hydroelectric power generation station with a certain scale.

### Embodiment 6 of the System for Generating Power by River Flow

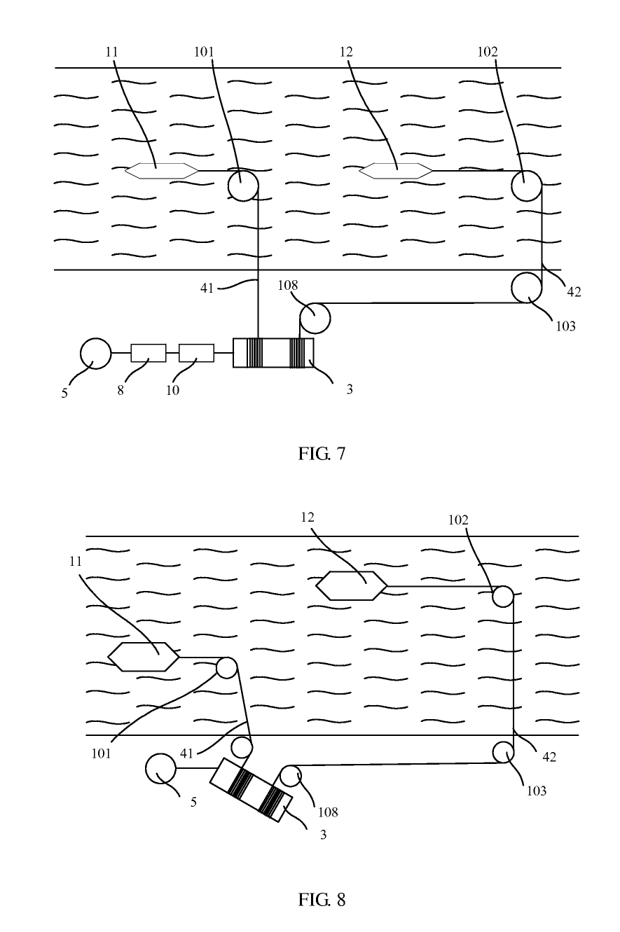

As shown in FIG. 7, it is a structure schematic view of Embodiment 6 of the system for generating power by river flow in accordance with the present invention. The present embodiment is similar to the solution of the Embodiment 5. There is one wheel disc 3 which is connected to the power generator 5 through the clutch 10 and the transmission 8. The wheel disc 3 is provided with two flexible chains independently wound by a pulley thereon i.e. a first flexible chain 41 and a second flexible chain 42. One of the flexible chains is in a winding status and the other flexible chain is in a loosing status. One of each flexible chain is respectively connected with a floating body i.e. a first floating body 11 and a second floating body 12. One of the floating bodies runs downstream with the push of the water current. The connected flexible chain is loosened and drives the wheel disc 3 to rotate so as to drive the power generator 5 to rotate for generating power. The other floating body runs upstream under the driving of the rotated wheel disc 3. Two floating bodies run downstream and upstream alternately. The difference between the present embodiment and the Embodiment 5 lies in that the flexible chains of the two floating bodies are connected to the wheel disc 3 through a pulley block. The running scopes of the two floating bodies are not overlapped in the flowing direction of the water current. As shown in FIG. 7, the first flexible chain 41 of the first floating body 11 is connected to the wheel disc 3 disposed on the bank through the first pulley 101. The second flexible chain 42 of the second floating body 12 is connected to the wheel disc 3 disposed on the bank through the second pulley 102, the third pulley 103 and the fourth pulley 108. The running lines of the first floating body 11 and the second floating body 12 are in series and are not overlapped each other.

Alternatively, the FIG. 8 is a structure schematic view of Embodiment 6 of the system for generating power by river flow in accordance with the present invention. The first floating body and the second floating body keeps a certain distance in the direction of the water current so as to avoid influence to each other. The first flexible chain and the second flexible chain are connected to the wheel disc by disposing the pulley suitably.

The technical solution of the present embodiment may enable the two floating bodies to alternately drive the power generator for continuous power generation. Their running scopes are not overlapped so as to prevent the flexible chains of the floating bodies from twisting or disturbing with each other.

### Embodiment 7 of the System for Generating Power by River Flow

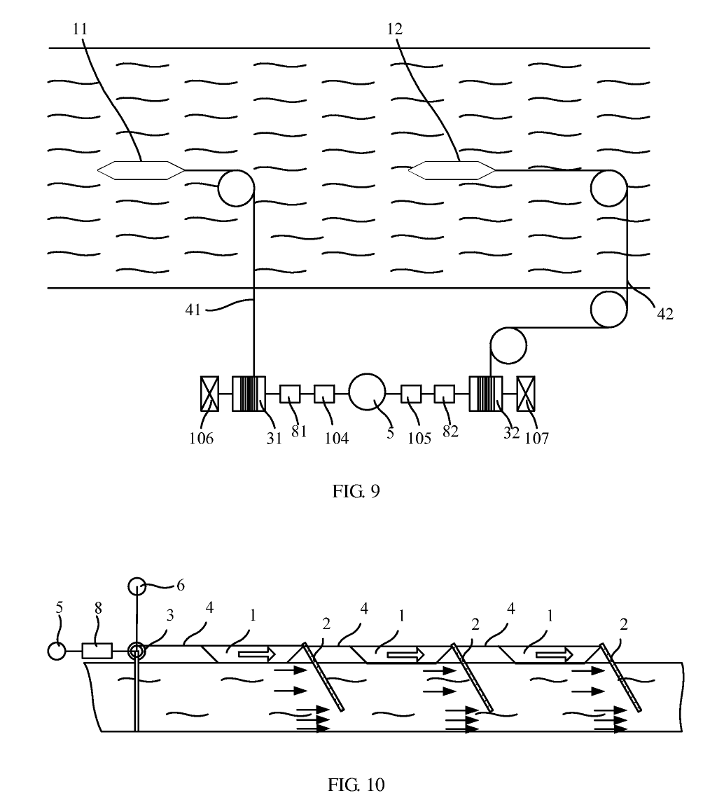

As shown in FIG. 9, it is a structure schematic view of Embodiment 7 of the system for generating power by river flow in accordance with the present invention. In the present embodiment, there are two wheel discs i.e. a first wheel disc 31 and a second wheel disc 32 which are respectively wound with one flexible chain i.e. a first flexible chain 41 and a second flexible chain 42. One of the flexible chains is in a winding state and the other flexible chain is in a loosing state. There is one power generator 5. A first transmission 81 and a second transmission 82 respectively connected with the rotation axis of the first wheel disc 31 and rotation axis of second wheel disc 32 are connected to the power generator 5 through the first engaging and disengaging gear 104 and the second engaging and disengaging gear 105 respectively. The first engaging and disengaging gear 104 and the second engaging and disengaging gear 105 may specifically be a clutch or a ratchet wheel. The other end of the rotation axis of the first wheel disc 31 is connected to the fourth power device 106. The other end of the rotation axis of the second wheel disc 32 is connected to the fifth power device 107. One end of each flexible chain is respectively connected with a floating body i.e. a first floating body 11 and a second floating body 12. The flexible chains of the two floating bodies are respectively connected to their own wheel discs through a pulley block. One of the floating bodies runs downstream with the push of the water current and drives the connected wheel disc to rotate so as to drive the power generator 5 to rotate for generating power. The wheel disc connected to the other floating body rotates under its power device's driving so as to drive the connected floating body to run upstream. Preferably, the running scopes of the two floating bodies are not overlapped in the flowing direction of the water current.

The present embodiment further adopts the combination of the two groups of wheel discs, flexible chains and floating bodies. Two wheel discs drive one power generator for generating power, and the clutches control the engagement and disconnection between the wheel discs and the power generators. The wheel discs, the clutches, the power generator and the power devices may be fixedly disposed at a place on the bank and then they may be connected to the floating bodies through pulley blocks and flexible chains. Two floating bodies alternately generate power downstream and return upstream and drive the floating bodies to return upstream by the power devices. Preferably, the speed of the floating bodies returning upstream is greater than the speed of the floating bodies running downstream, which may ensure that there is a time period to such as retract the baffles for the returned floating bodies and the power generator can continuously generate power.

### Embodiment 8 of the System for Generating Power by River Flow

As shown in FIG. 10, it is a structure schematic view of Embodiment 8 of the system for generating power by river flow in accordance with the present invention. The present embodiment is based on the above embodiment and may be further provided with two or more floating bodies 1 disposed in series along the direction of the water current. Each floating body 1 may be connected to the flexible chain 4 or each divided flexible chain 4 may be connected end to end.

The technical solution of the present embodiment enables the floating bodies to run downstream for generating power at the same time and run upstream to return back to the starting point under one power device's driving. A plurality of floating bodies are running downstream at the same time, which may strengthen the ability to generate power.

### An Embodiment of the Method for Generating Power by River Flow

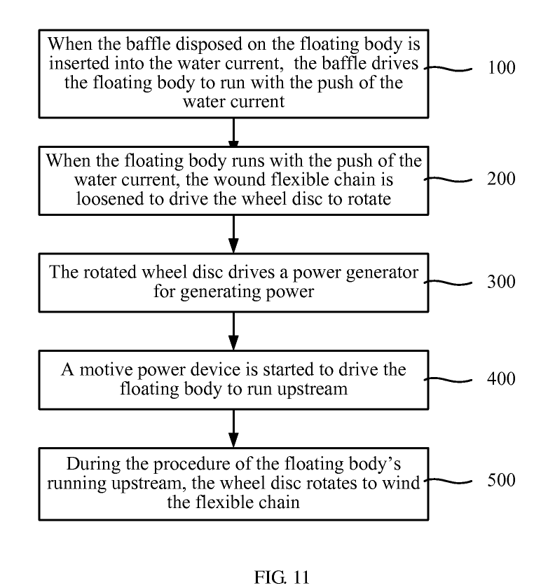

As shown in FIG. 11, it is a flowchart of the embodiment of the method for generating power by river flow in accordance with the present invention. The method includes the following steps:

Step 100: When the baffle disposed on the floating body is inserted into the water current, an angle is formed between the baffle and the flowing direction of the water current, which is preferably 90°; with the push of the water current, the baffle drives the floating body to run downstream; the floating body is connected to one end of a flexible chain; the other end of the flexible chain is wound around a wheel disc fixedly disposed relatively to the water current.

Step 200: When the floating body runs downstream with the push of the water current, the floating body drags the wound flexible chain to drive the wheel disc to rotate.

Step 300: The rotated wheel disc drives a power generator for generating power.

The method for generating power by river flow of the present embodiment may be specifically executed by the system for generating power by river flow of the embodiments in accordance with the present invention. The water current pushes the baffle to drive the floating body to run; horizontal movement of the floating body is transformed into rotation of the wheel disc through the flexible chain so as to drive the power generator for generating power. The technical solution of the present embodiment does not directly transform the kinetic energy of the water current in the manner of horizontal movement into the rotation of the turbomachine. Instead, it directly transforms the kinetic energy into the horizontal movement of the floating body and then transforms the horizontal movement into the rotation of the wheel disc. Such transformation of the kinetic energy can overcome the problem that the kinetic energy of the water current can not be fully utilized because of direction variation of the turbomachine's blade in the water current so as to reduce the loss of kinetic energy, utilize water current resource to the maximum extent and increase the amount of power generation.

Based on the present embodiment, in order to ensure the operational continuity of power generation by the floating body, there may be the following steps executed after the step 300 to drive the floating body to return back upstream:

Step 400: a power device is started to drive the floating body to run upstream;

Step 500: during the procedure of the floating body's running upstream, the wheel disc rotates to wind the flexible chain.

The specific implementation manner of the above step 400 may be that a motive power device disposed fixedly relatively to the water current, such as the first power device disposed in the system for generating power by river flow of the above embodiments, is start to drive the wheel disc to rotate to wind the loosened flexible chain around the wheel disc so as to drive the floating body to run upstream.

In order to reduce the resistance when the floating body returns back upstream, before starting the first power device, the baffle may be moved away from the water current. For example, when one end of the baffle is pivotally connected with the floating body, as mentioned in the embodiment of the power generation systems by river flow, a horizontal pivot spindle between one end of the baffle and the floating body may be driven to rotate until the pivoted baffle rotates to upwarp over the water surface or floating on the water surface so as to move away from the water current to reduce resistance.

Alternatively, when one end of the baffle is pivoted with the floating body, as mentioned in the embodiments of power generation systems by river flow, before starting the first power device, a vertical pivot spindle between one end of the baffle and the floating body may be driven to rotate until the baffle is driven to rotate to the downstream direction of the water current to reduce resistance.

Alternatively, as mentioned in the embodiments of power generation systems by river flow, the floating body may also be driven to rotate so as to drive the baffle fixedly disposed on the floating body to rotate until the baffle rotates to the downstream direction of the water current i.e. direction substantially parallel to the water current to reduce resistance.

Furthermore, in specific implementation, during the procedure of the floating body's running, the speed of the water current is detected to control the electrical parameter of the power generator so as to control the floating body to run at a predisposed speed with the push of the water current. The effective control to rotation speed can control rotation speed of the power generator, which facilitates obtaining electric energy with steady frequency and high quality. The torque imposed on the wheel disc by the floating body may also be controlled based on practical needs i.e. the power of the electric energy generated by the power generator is controlled.

The method for generating power by river flow of the present invention may specifically executed by any one embodiment of the system for generating power by river flow in accordance with the present invention. However, it is not only limited to this. The power generation system adapted to transform the motive power generated by the water current's flowing into horizontal movement of the floating body and then transform the horizontal movement of the floating body into rotation of the wheel disc fixedly disposed may also be used to execute the method for generating power by river flow of the present invention.

### Another Embodiment of Method for Generating Power by River Flow

Another embodiment of method for generating power by river flow in accordance with the present invention may be further provided with two groups of wheel discs, flexible chains and floating bodies which are connected together i.e. a first wheel disc, a first flexible chain and a first floating body as well as a second wheel disc, a second flexible chain and a second floating body. The two wheel discs are respectively connected to a power generator through a transmission, a first clutch and a second clutch. The method for generating power by river flow of the present embodiment is specifically as follows:

When the baffle disposed on the first floating body is inserted into the water current, the baffle drives the first floating body to run downstream with the push of the water current. The first floating body is connected to one end of the first flexible chain. The other end of the first flexible chain is wound around the first wheel disc fixedly disposed relatively to the water current.

When the first floating body runs downstream with the push of the water current, the first floating body drags the wound first flexible chain to drive the first wheel disc to rotate;

The rotated first wheel disc is engaged with the power generator through the first clutch and drives the power generator for generating power through the transmission;

At the same time when the first floating body drives the first wheel disc to rotate and drives the power generator for generating power, the second wheel disc is disconnected from the power generator through the second clutch and is driven by the connected first power device to rotate so as to wind the second flexible chain connected to the second wheel disc.

The wound second flexible chain drives the connected second floating body to run upstream.

The first floating body and the second floating body run downstream and upstream alternately and their running scopes are not overlapped in the flowing direction of the water current.

In the present embodiment, when one floating body runs downstream to drive the connected wheel disc to rotate, the transmission connected to this wheel disc drives the power generator to rotate for generating power through a clutch. At the same time, the wheel disc connected to the other floating body rotates under the first power device's driving to drive the floating body to run upstream. The wheel disc connected to the floating body running upstream is disconnected from the power generator through the other clutch. The two floating bodies run downstream and upstream alternately. The clutches respectively connected to the two bodies are connected to the power generator when the connected floating bodies run downstream and disconnect from the power generator when the connected floating bodies run upstream. Preferably, the speed of the power device to drive one floating body to run upstream is greater than the speed of the other floating body's running downstream, which may ensure that there is a time period to such as retract the baffles for the returned floating bodies and the power generator can continuously generate power. The above technical solution may be specifically implemented by adopting but not limited to the device of the Embodiment 7 of the system for generating power by river flow in accordance with the present invention.

Though illustration and description of the present disclosure have been given with reference to preferred embodiments thereof, it should be appreciated by persons of ordinary skill in the art that various changes in forms and details can be made without deviation from the spirit and scope of this disclosure, which are defined by the appended claims.

What is claimed is:

1. A system for generating power by river flow, comprising:
a wheel disc fixedly disposed relatively to water current;
a floating body floating on the water current;
a baffle disposed on the floating body, inserted into the water current during generating power, and driving the floating body to run downstream with the push of the water current;
a flexible chain with one end fixedly connected to the floating body and the other end wound around the wheel disc, and dragged to drive the wheel disc to rotate when the floating body runs downstream with the push of the water current; and
a power generator connected to a rotation axis of the wheel disc through a transmission, and driven for generating power when the wheel disc rotates.

2. The system according to claim 1, further comprising:
a first power device connected to the wheel disc and adapted to drive the wheel disc to rotate to wind the loosened flexible chain around the wheel disc so as to drive the floating body to run upstream when generating power stops.

3. The system according to claim 1, wherein one end of the baffle is pivotally connected with the floating body, a pivot spindle is disposed horizontally and connected with a third power device, and the third power device drives the pivot spindle to rotate so as to drive the baffle to rotate until the baffle moves away from the water current when the floating body runs upstream.

4. The system according to claim 1, wherein one end of the baffle is pivotally connected with the floating body, a pivot spindle is disposed vertically and connected with a third power device, and the third power device drives the pivot spindle to rotate so as to drive the baffle to rotate to a downstream direction of the water current when the floating body runs upstream.

5. The system according to claim 1, further comprising:
a third power device disposed on the floating body and adapted to drive the floating body to rotate so as to drive the baffle to rotate to a downstream direction of the water current when the floating body runs upstream.

6. The system according to claim 1, wherein the floating body is provided with a plurality of baffles disposed side by side or paratacticly.

7. The system according to claim 1, wherein there are two wheel discs with one flexible chain respectively wound thereon, one of the flexible chains is in a winding state, and the other flexible chain is in a loosing state; there is one power generator, two transmissions respectively connected to rotation axis of the two wheel discs are connected to two ends of the power generator respectively through a engaging and disengaging gear, and the other ends of the rotation axes of the two wheel discs are respectively connected to a power device; one end of each flexible chain is connected with one floating body respectively, and flexible chains of the two floating bodies are connected with the wheel discs respectively through a pulley block; one of the floating bodies runs downstream with the push of the water current and drives the wheel disc to rotate so as to drive the power generator to rotate for generating power, and the wheel disc connected to the other floating body rotates under the connected power device's driving so as to drive the connected floating body to run upstream; running scopes of the two floating bodies are not overlapped in a flowing direction of the water current.

8. The system according to claim 7, wherein the engaging and disengaging gear is a clutch or a ratchet wheel.

9. The system according to claim 1, wherein there are two flexible chains and one end of each of the two flexible chains is wound and connected to the wheel disc; there are two floating bodies respectively connected to the other ends of the two flexible chains; the baffle of one of the two floating bodies is inserted into the water current to drive the floating body to run downstream with the push of the water current, draw the connected flexible chain to be loosened and drive the wheel disc to rotate; the rotated wheel disc winds the flexible chain connected to the other floating body around the rotated wheel disc and draws the floating body to run upstream, and the two floating bodies run downstream and upstream alternately.

10. The system according to claim 9, wherein a commutator is connected between the wheel disc and the power generator.

11. The system according to claim 1, wherein there are two or more floating bodies disposed in series along a direction of the water current, and each of the floating bodies is connected to the flexible chain.

12. A method for generating power by river flow, comprising:
a baffle driving a floating body to run downstream with the push of water current when the baffle disposed on a floating body is inserted into the water current, wherein the floating body is connected one end of a flexible chain, the other end of the flexible chain is wound around a wheel disc fixedly disposed relatively to the water current;
the floating body dragging the wound flexible chain to drive the wheel disc to rotate when the floating body runs downstream with the push of the water current; and
the rotated wheel disc driving a power generator for generating power.

13. The method according to claim 12, after the floating body runs until the flexible chain is loosened from the wheel disc, further comprising:
starting a first power device to drive the wheel disc to rotate to wind the flexible chain around the wheel disc so as to drive the floating body to run upstream.

14. The method according to claim 13, before starting the first power device, further comprising:
moving the baffle away from the water current.

15. The method according to claim 14, wherein the step of moving the baffle away from the water current specifically comprises: driving a pivot spindle between an end of the baffle and the floating body to rotate until the baffle is driven to move away from the water current.

16. The method according to claim 13, before starting the first power device, further comprising: driving a pivot spindle between an end of the baffle and the floating body to rotate until the baffle is driven to rotate to a downstream direction of the water current.

17. The method according to claim 13, before starting the first power device, further comprising: driving the floating body to rotate to drive the baffle so as to rotate until the baffle rotates to a downstream direction of the water current.

18. A method for generating power by river flow, comprising:
a baffle driving a first floating body to run downstream with the push of the water current when the baffle disposed on the first floating body is inserted into water current, wherein the first floating body is connected with one end of a first flexible chain, the other end of the first flexible chain is wound around a first wheel disc fixedly disposed relatively to the water current;
dragging the wound first flexible chain to drive the first wheel disc to rotate when the first floating body runs downstream with the push of the water current;
the rotated first wheel disc engaging with a power generator through a first clutch and driving the power generator for generating power through a transmission;
at the same time, disconnecting a second wheel disc from the power generator through a second clutch, making the second wheel disc rotate under the first power device's driving, and winding the second flexible chain connected to the second wheel disc;
the wound second flexible chain driving the connected second floating body to run upstream; and
the first floating body and the second floating body running downstream and upstream alternately, wherein running scopes are not overlapped in a flowing direction of the water current.
